(19) United States
(12) Patent Application Publication
(10) Pub. No.: US 2015/0360816 A1
(43) Pub. Date: Dec. 17, 2015

(54) THREE-DIMENSIONAL MULTILAYER STRUCTURE FOR FOOD VESSEL AND METHOD FOR MANUFACTURING THE SAME

(71) Applicant: CHING-TIEN CHEN, Tainan (TW)

(72) Inventor: CHING-TIEN CHEN, Tainan (TW)

(21) Appl. No.: 14/305,451

(22) Filed: Jun. 16, 2014

(51) Int. Cl. B65D 25/14; B29C 33/38; B29C 65/14; A47G 19/12

(52) U.S. Cl. CPC B65D 25/14; A47G 19/12; B29C 33/3842; B29C 33/3835; B29C 65/14; B29L 2031/7132

(57) ABSTRACT

A three-dimensional multilayer structure of a food vessel includes an inner container and an outer container. The inner container includes a first accommodation space, a wall layer encircling the first accommodation space, and a pattern formed on a surface of the wall layer outside the first accommodation space. The pattern is formed by a plurality of recessed surfaces that are formed at different depths. The outer container includes a second accommodation space for accommodating the inner container, and a light transmissive wall layer encircling the second accommodation space. The inner container and the outer container are formed by injection molding. Thus, the three-dimensional multilayer structure of the food vessel of the present invention may provide a visual effect such as an embossment, and may be fabricated with different patterns according to user's requirements.

### FIELD OF THE INVENTION

The present invention relates to a three-dimensional multilayer structure of a food vessel and a method for manufacturing the same, particularly to a three-dimensional multilayer structure of a food vessel providing highly realistic stereoscopic visual effects, and a method for manufacturing the same.

### BACKGROUND OF THE INVENTION

Ethnic groups around the world have their special dietary cultures, which generates diversified food vessels. On the market, surfaces or bottom parts of food vessels are usually decorated with patterns and designs to satisfy different consumer preferences. However, most common food vessels on the market have only planar designs. Although there are a few food vessels having three-dimensional designs, they are hard to be mass produced and usually serve as art collectibles. Further, pigments applied on food vessels may be toxic. Under long-term using, the pigments may come off the surfaces and be partially taken in by an unknowing user, leading to utilization safety concerns.

The US Patent Publication No. US 2010/0321797 A1 discloses an optical illusion device such as a drinking glass/cup for providing a multi-dimensional visual display. The disclosed device is made of a transparent material such as glass, and includes a body with a tubular sidewall to dispose a decorative pattern. The body is covered by a cover layer on which another decorative pattern is disposed. Through a design of a reflective surface, when a user observes from outside the body, the body and the cover layer generate visual effects such as multi-layered imagery. However, the decorative patterns in the above disclosure are two-dimensional design patterns, which generate a multi-layered image by means such as a lens and thus lack vividness. Therefore, the current technique still needs to be improved.

### SUMMARY OF THE INVENTION

The primary object of the present invention is to solve an issue of the prior art that a decorative design of a food vessel lacks vividness.

To solve the above issue, a three-dimensional multilayer structure of a food vessel is provided by the present invention. The three-dimensional multilayer structure includes an inner container and an outer container. The inner container includes a first accommodation space, a wall encircling the first accommodation space, and a pattern formed on a surface of the wall outside the first accommodation space. The pattern is formed by a plurality of recessed surfaces that are formed at different depths and interlaced with each other. The outer container includes a second accommodation space for accommodating the inner container, and a light-pervious wall encircling the second accommodation space. The inner container and the outer container are formed by injection molding.

In one embodiment, the three-dimensional multilayer structure of the food vessel further includes an opening ring. The opening ring includes a main body, a coupling portion sunken from the main body to couple on and cover upper edges of the outer container and the inner container, and an arched surface disposed at a side of the body opposite the coupling portion.

Further, in the three-dimensional multilayer structure of the food vessel, the inner container includes a flange extending outward to cover the upper edge of the outer container.

Further, in the three-dimensional layered-wall structure for a food vessel, the plurality of recessed surfaces are colored.

Another object of the present invention is providing a method for manufacturing the three-dimensional multilayer structure of the food vessel as stated above. The method includes following steps. In step S1, a three-dimensional coordinate system is established, and a model of an inner container is defined in the three-dimensional coordinate system. In step S2, a pattern is projected to a surface of the model of the inner container in the three-dimensional coordinate system. In step S3, the pattern is transformed into a plurality of recessed surfaces according to colors and textures of the pattern, and the plurality of recessed surfaces are set to be formed at different depths. In step S4, a computer numerical control (CNC) machine tool is controlled to produce an injection mold based on the model of the inner container. In step S5, the inner container is formed by injection molding through using the injection mold. In step S6, the plurality of recessed surfaces of the inner container are colored according to the colors and the textures of the pattern. In step S7, a light transmissive outer container is provided, and then the outer container and the inner container are assembled to perform a sealing procedure on the assembly of the inner container and the outer container. In step S8, assembly of the three-dimensional multilayer structure of the food vessel of the present invention is finished.

Further, in the method for manufacturing the three-dimensional multilayer structure of the food vessel, the sealing procedure in step S7 includes step S71, in which an opening ring is provided to couple on and cover the upper edges of the outer container and the inner container.

Further, in the method for manufacturing the three-dimensional multilayer structure of the food vessel, the sealing procedure in step S7 includes step S72, in which a high-frequency welding apparatus is provided to heat and weld the upper edge of the inner container to form a flange at the upper edge of the inner container. The flange extends outward to cover the upper edge of the outer container.

Further, in the method for manufacturing the three-dimensional multilayer structure of the food vessel, the three-dimensional coordinate system is a cylindrical coordinate system.

Comparing to the prior art, the present invention offers following features.

First of all, in the three-dimensional multilayer structure of the food vessel of the present invention, the pattern formed on a wall of the inner container having visible effects as an embossment, thus can achieve more realistic three-dimensional visual effects compared to the prior art. The pattern of the inner container is produced through projection, in a way that a two-dimensional photograph may be converted to a three-dimensional form on the wall to offer customized choices. Further, as the method for manufacturing the three-dimensional multilayer structure of the food vessel of the present invention is performed by injection molding, the method of the invention is suitable for mass production by an automated production line.

Secondly, in the present invention, by assembling the inner container with the outer container, the overall three-dimensional multilayer structure of the food vessel appears laminated visual effect. Further, since the inner container is covered by the outer container, the overall three-dimensional multilayer structure of the invention prevents a user from directly coming into contact with potentially toxic pigments.

The foregoing, as well as additional objects, features and advantages of the invention will be more readily apparent from the following detailed description of preferred embodiments, which proceed with reference to the accompanying drawings.

### BRIEF DESCRIPTION OF THE DRAWINGS

FIG. 1 is a flowchart of a method of the present invention;

FIG. 2A is a schematic diagram of an inner container according to a first embodiment of the present invention;

FIG. 2B is a sectional view taken on line 2B-2B of FIG. 2A;

FIG. 2C is an enlarged sectional view of the circled portion of FIG. 2B;

FIG. 3 is a schematic diagram of the inner container after being colored according to the first embodiment of the present invention;

FIG. 4 and FIG. 5 are schematic diagrams showing an assembly of the inner container and the outer container according to the first embodiment of the present invention;

FIG. 6A is a schematic diagram of an opening ring assembled with the inner container and the outer container according to the first embodiment of the present invention;

FIG. 6B is a partial sectional view of the assembly opening ring in FIG. 6A;

FIG. 7 is a partial sectional view of the inner container according to a second embodiment of the present invention;

FIG. 8 is a sectional view of assembly of the inner container and the outer container according to a second embodiment of the present invention;

FIG. 9 is a schematic view of a three-dimensional multilayer structure of the food vessel according to a third embodiment of the present invention; and

FIG. 10 is a schematic view of a three-dimensional multilayer structure of the food vessel according to a fourth embodiment of the present invention.

### DETAILED DESCRIPTION OF THE PREFERRED EMBODIMENTS

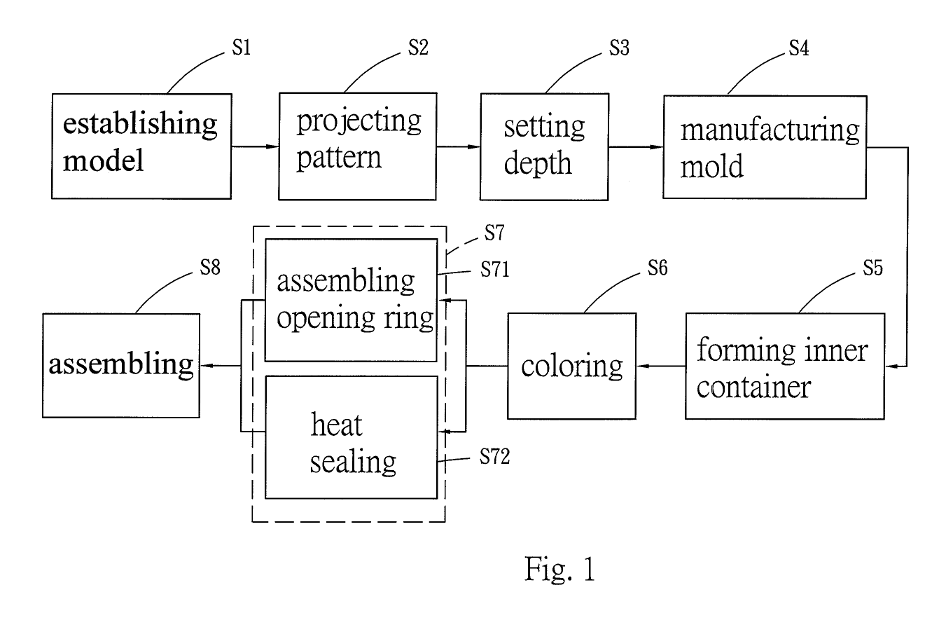

FIG. 1 shows a flowchart of a method for making a three-dimensional multilayer structure 1 of a food vessel. The method may be performed through using a computer controlling a computer numerical control (CNC) machine tool and an injection molding machine. The computer controls the CNC machine tool by a computer-aided design software and a computer-aided manufacturing software to manufacture an injection mold, and then the injection molding machine apply the injection mold to inject a finished product. More specifically, the method for making the three-dimensional multilayer structure of the food vessel includes the following steps.

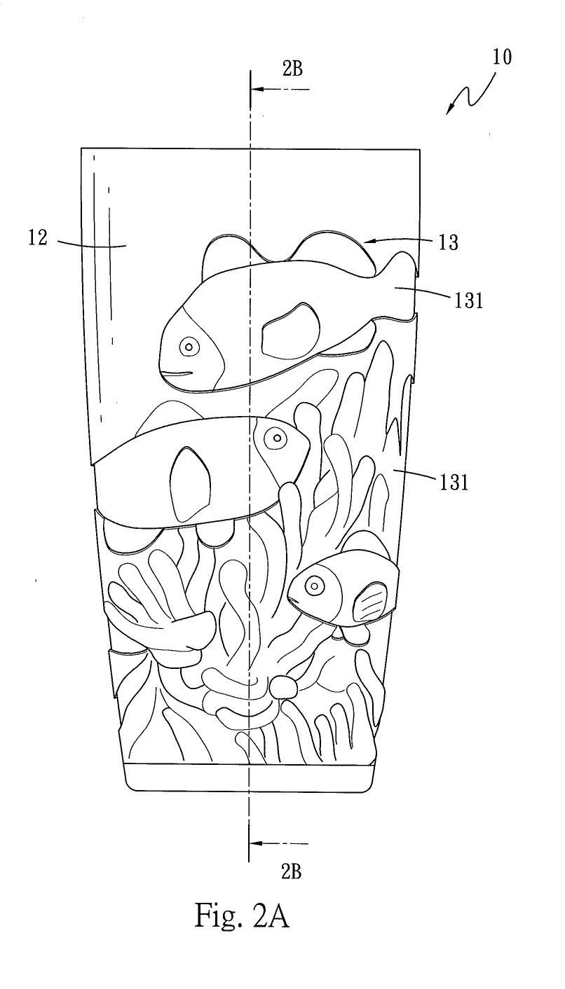

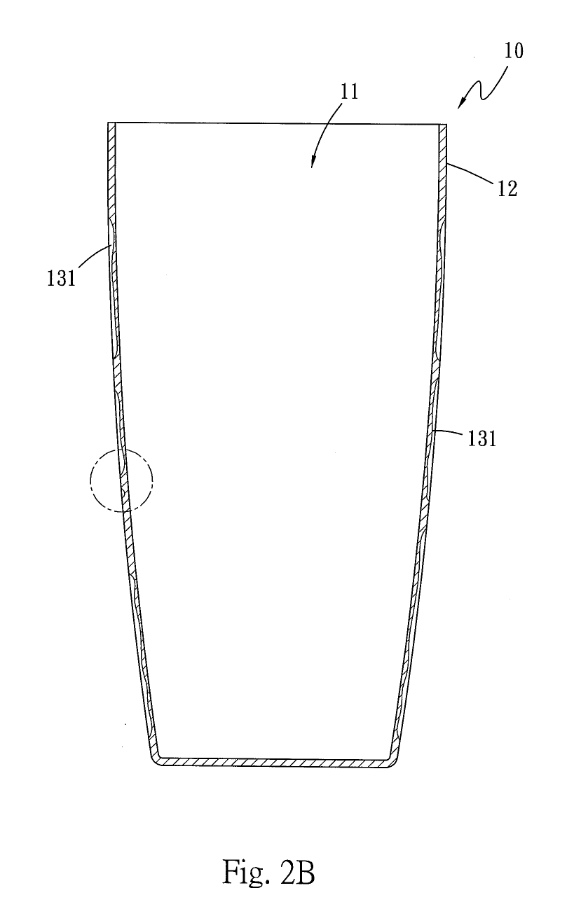

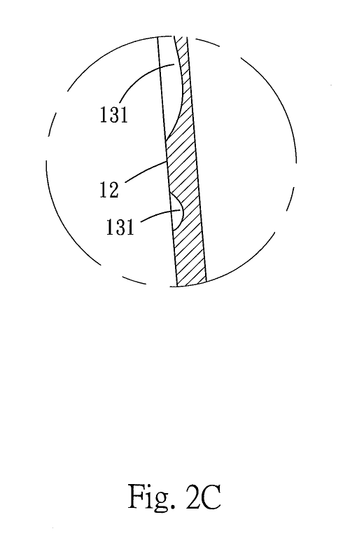

In step S1, a three-dimensional coordinate system is established, and a model of an inner container 10 is defined in the three-dimensional coordinate system (referring to FIG. 2A). The model of the inner container 10 is a template for manufacturing the injection mold, and is defined with a configuration such as a gate and a parting line for injection molding. The term “three-dimensional coordinate system” in the present invention refers to a simulated space established through the computer-aided design software model of the inner container 10 is established to construct computer graphics. In one embodiment, preferably, the three-dimensional coordinate system is a cylindrical coordinate system.

In step S2, a pattern 13 is projected to an outer surface of the model of the inner container 10 in the three-dimensional space coordinate system. In this step, the pattern 13 may be a planar image that is projected onto the model of the inner container 10 (referring to FIG. 2A) through coordinate transformation. The pattern 13 may also be a three-dimensional image or an image of other storage format.

In step S3, the pattern is transformed into a plurality of recessed surfaces 131 according to colors and textures of the pattern 13, and the recessed surfaces 13 are set to be formed at different depths (referring to FIG. 2A). In this step, to allow final products manufactured by using the method to be separated from the injection mold smoothly, while setting the depths of the plurality of recessed surfaces 131, at least one mold opening direction is defined according to the positions of the gate and the parting line. If the plurality of recessed surfaces 131 overlap along the mold opening direction, in the overlapping parts only the recessed surface 131 with the smallest depth will be kept but the remaining recessed surfaces 131 are removed. Thus, the inner container 10 formed may give a three-dimensional sensation with a depth of field, and the recessed surfaces 131 that hinder a molding opening process can be eliminated.

In step S4, the computer controls the CNC machine tool to manufacture the injection mold based on the model of the inner container 10. For example, the CNC machine tool may manufacture the injection mold by cutting a steel material, or by other conventional methods. It should be noted that the present invention does not limit the method for manufacturing the injection mold.

In step S5, the inner container 10 is formed by injection molding according to the injection mold. FIG. 2A shows a schematic diagram of an appearance of an inner container 10 of a first embodiment of the present invention. In this step, the inner container 10 formed by injection molding is an uncolored semifinished product, and includes the plurality of recessed surfaces 131 formed at an outer surface of the inner container 10 to form the pattern 13. FIG. 2B shows a section view along 2B-2B in FIG. 2A. FIG. 2C shows an enlarged partial section view of FIG. 2. Please also refer to FIG. 2B and FIG. 2C, the plurality of recessed surfaces 131 are formed on the outer surface of the inner container 10 and have different depths, to provide the pattern 13 with a three-dimensional visual effect.

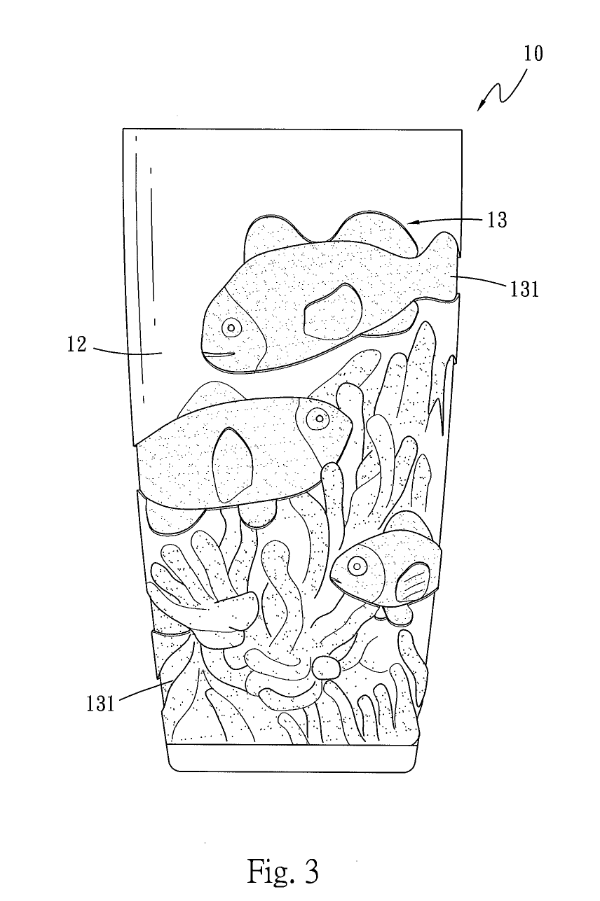

In step S6, the plurality of recessed surfaces 131 of the inner container 10 are colored according to the colors and textures of the pattern 13. FIG. 3 shows a schematic diagram of the inner container 10 after being colored. In practice, this process may be performed by a paint spray device or performed manually. Alternatively, the plurality of recessed surfaces 131 may be colored by any known conventional method.

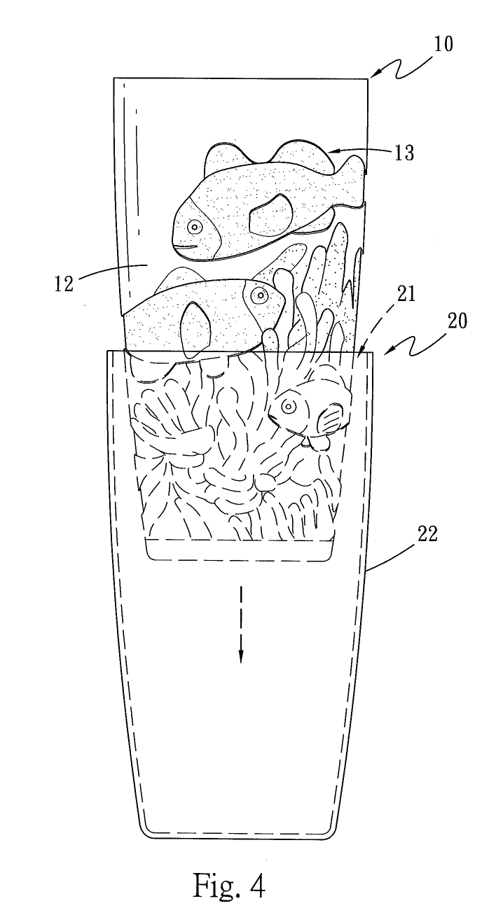

In step S7, a light transmissive outer container 20 is provided, and then the inner container 10 and the outer container 20 are assembled together to perform a sealing procedure on the assembly of the inner container 10 and the outer container 20. FIG. 4 and FIG. 5 are schematic diagrams showing an assembly of the inner container 10 and an outer container 20 of the first embodiment of the present invention. In the embodiment, the outer container 20 is a vessel that slightly larger than the inner container 10, and is capable of accommodating the inner container 10 in a second accommodation space 21 to perform assembly. The outer container 20 may be formed by injection molding through another mold. Or, the injection mold stated in the foregoing steps can be designed to inject the inner mold 10 and the outer mold 20 together. The above method for manufacturing the outer container 20 is an example for explaining but not limiting the present invention.

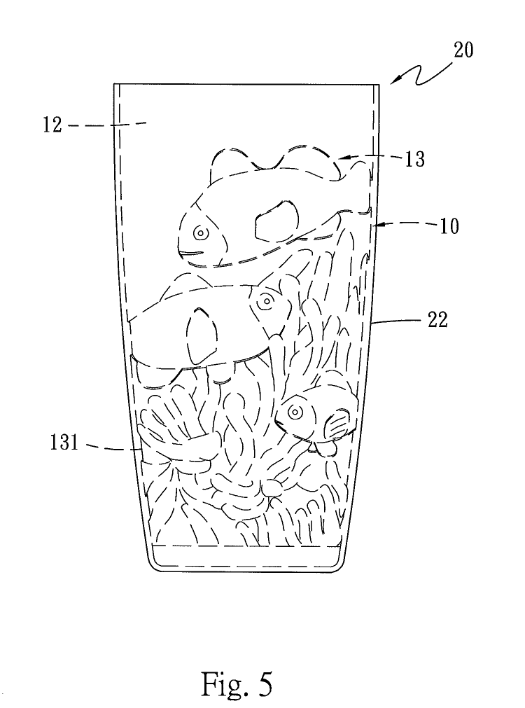

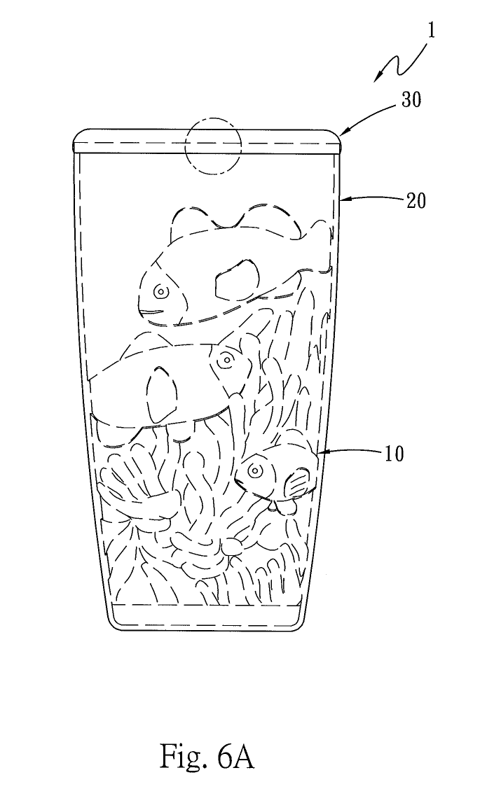

Please refer to FIGS. 6A and 6B. The inner container 10 and the outer container 20 include upper edges that are formed as flat edges after being separated from the injection mold. To alleviate discomforts of a user's mouth caused by contacting the sharp upper edges, a sealing procedure is provided by the present invention to render the upper edges of the inner container 10 and the outer container 20 become smooth. In the first embodiment, the sealing procedure is achieved by a step S71 of the step S7. In step S71, an opening ring 30 is provided to couple on and cover the upper edges of the outer container 20 and the inner container 10. The opening ring 30 is capable of connecting the inner container 10 and the outer container 20 and covering the sharp upper edges of the inner container 10 and the outer container 20.

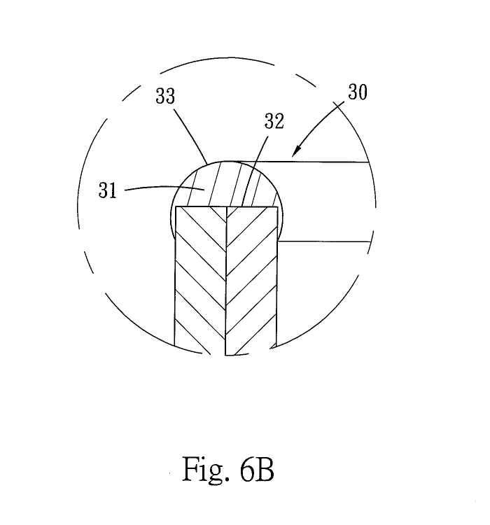

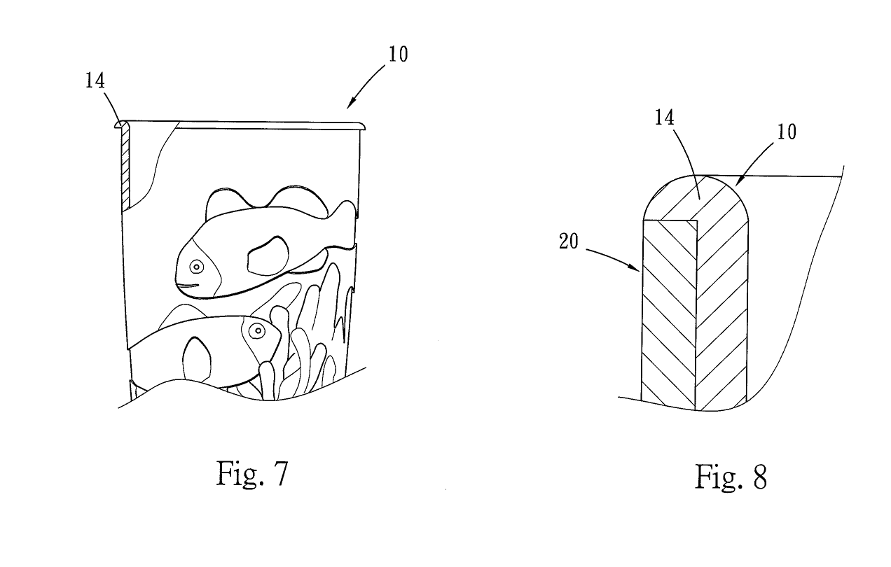

As shown in FIG. 7, in a second embodiment of the invention, the sealing procedure is achieved by a step S72 of the step S7. In step S72, a welding procedure is performed. More specifically, a high-frequency welding apparatus is provided to heat and weld the upper edge of the inner container 10, such that the upper edge of the inner container 10 forms a flange 14 that extends outward and covers the upper edge of the outer container 20 (referring to FIG. 8). As such, the upper edges of the inner container 10 and the outer container 20 become smooth to achieve the effect of preventing the user's mouth from being scratched by the sharp upper edges. Alternatively, the flange 14 can be formed with the inner container 10 at the same time by injection molding

In step S8, the three-dimensional multilayer structure 1 of the food vessel is accomplished. In the present invention, a three-dimensional multilayer structure 1 of the food vessel is formed by combining the inner container 10 and the outer container 20, so as to provide stereoscopic visual effects. The food vessel may be a container that holds foods or drinks, such as cups, plates and bowls, but not the limitation.

Detailed structures and compositions of the three-dimensional multilayer structure 1 of the food vessel of the present invention are further described below. More specifically, referring to FIG. 2A and FIG. 2B again, the inner container 10 includes a first accommodation space 11, a wall 12 encircling the first accommodation space 11, and a pattern 13 formed on a surface of the wall 12 outside the first accommodation space 11. The pattern 13 is formed by the plurality of recessed surfaces 131 that are formed at different depths and interlaced with each other, thus make the pattern 13 appear a visible effect such as an embossment. Referring to FIG. 2C, the plurality of recessed surfaces 131 formed on the wall 12 have different depths, which forms the stereoscopic laminated visual effects three-dimensional layers of the pattern 13.

As shown in FIG. 4, the outer container 20 includes a second accommodation space 21 for accommodating the inner container 10, and a light transmissive wall 22 encircling the second accommodation space 21. The light transmissive wall 22 is made by a transparent or translucent material for covering the wall 12 with the pattern 13 of the inner container 10, so as to display a stereoscopic laminated visual effect of the pattern 13 of the three-dimensional multilayer structure 1. Further, the plurality of recessed surfaces 131 may be colored by means such as paint spraying or the like. Due to the pigments for coloring may be toxic, the plurality of recessed surfaces 131 at the outer surface of the inner container 10 are covered by the outer container 20 to prevent the user from coming into contact with the pigments.

Referring to FIG. 6B, in the first embodiment of the present invention, the three-dimensional multilayer structure 1 of the food vessel may further include an opening ring 30 for coupling on and covering the upper edges of the outer container 20 and the inner container 10. The opening ring 30 includes a main body 31, a coupling portion 32 sunken from the main body 31, and an arched surface 33 disposed at a side of the main body 31 opposite the coupling portion 32. A width of the coupling portion 32 is adequate for exactly coupling on the upper edges of the inner container 10 and the outer container 20. Thus, the user's mouth only comes into contact with the smoother arched surface 33 of the opening ring 30 during using, so as to prevent the user mouth from getting scratched.

FIGS. 7 and 8 show the inner container 10 according to the second embodiment of the present invention. In the second embodiment, the upper edge of the inner container 10 is provided with a flange 14 that extends outward to cover the upper edge of the outer container 20. The flange 14 may be formed by performing thermal pressing on the upper edge of the inner container 10 to achieve an equivalent effect of the foregoing opening ring 30 in the first embodiment.

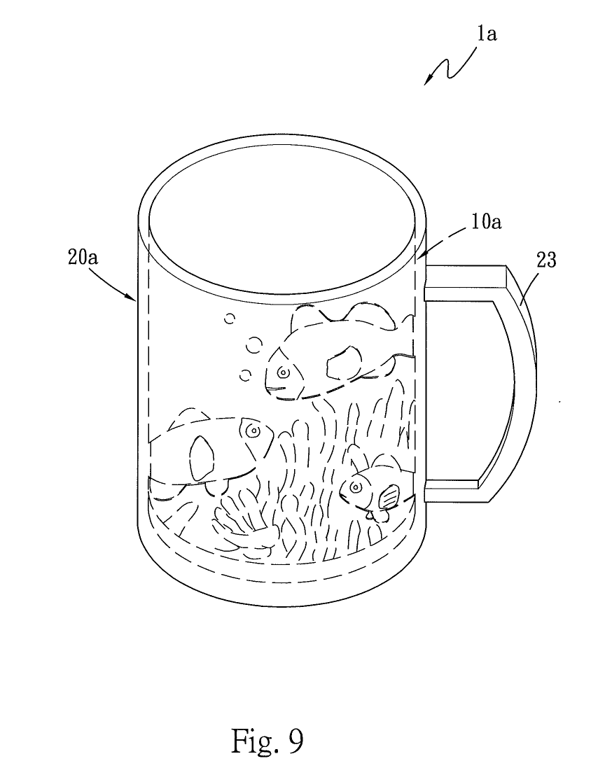

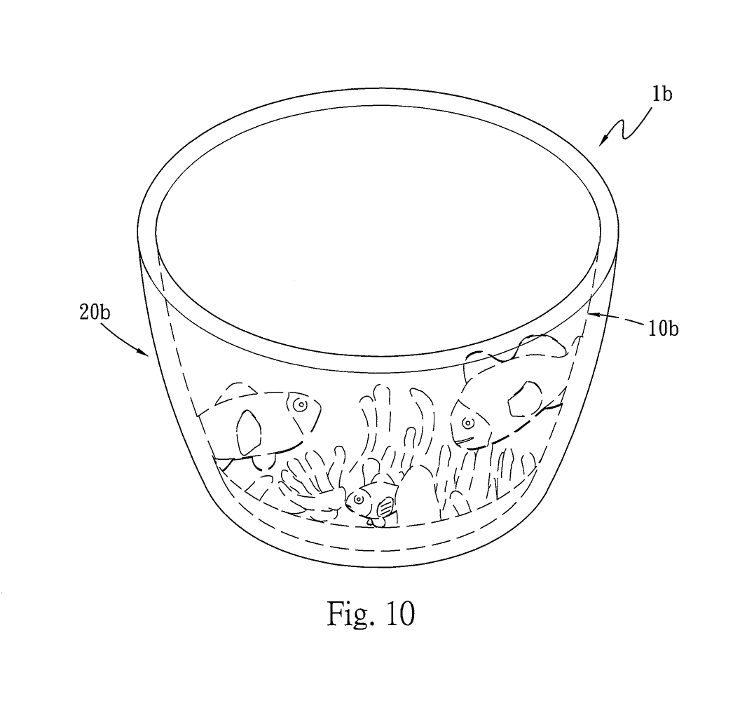

The three-dimensional multilayer structure 1 of the present invention is applicable to various kinds of food vessels. FIGS. 8 and 9 respectively show schematic diagrams of a third embodiment and a fourth embodiment of the present invention. As shown in FIG. 9, in the third embodiment of the present invention, an inner container 10a and an outer container 20a of a three-dimensional multilayer structure la are cups such as a mug or a beer glass, wherein a handle 23 is attached on the outer container 20a. Referring to FIG. 10 for the fourth embodiment of the present invention, bottoms and openings of an inner container 10b and an outer container 20b of a three-dimensional multilayer structure lb are formed as a bowl shape, such as a salad bowl or the like. Namely, the present invention can be apply to manufacture different kinds of food vessels according to market requirements. It should be noted that the described embodiments are for one person skilled in the art to better understand the present invention, and are not to be construed as limitations to the present invention.

In conclusion, the three-dimensional multilayer structure 1 of a food vessel and the method for manufacturing the same of the present invention are as disclosed above. In the present invention, compared to the prior art, the inner container 10 having the wall 12 with embossment-like pattern is formed through injection molding to achieve more vivid and realistic three-dimensional visual effects. The inner container 10 and the outer container 20 are manufactured by injection molding that is suitable for mass production using an automated production line. Further, through assembly of the inner container 10 and the outer container 20, the present invention can not only provide a stereoscopic and laminated visual effect but also effectively prevent a user from coming into contact with potentially toxic pigments.

What is claimed is:

1. A three-dimensional multilayer structure of a food vessel, comprising:
an inner container, comprising a first accommodation space, a wall encircling the first accommodation space, and a pattern formed on a surface of the wall outside the first accommodation space, wherein the pattern is formed by a plurality of recessed surfaces that are formed at different depths and interlaced with each other; and
an outer container, comprising a second accommodation space for accommodating the inner container, and a light transmissive wall encircling the second accommodation space;
wherein the inner container and the outer container are formed by injection molding.

2. The three-dimensional multilayer structure of claim 1 further comprising an opening ring which comprises a main body, a coupling portion sunken from the main body to couple on and cover upper edges of the outer container and the inner container, and an arched surface disposed at a side of the main body opposite the coupling portion.

3. The three-dimensional multilayer structure of claim 1, wherein the inner container further comprises a flange formed at an upper edge thereof and extending outward to cover an upper edge of the outer container.

4. The three-dimensional multilayer structure of claim 1, wherein the plurality of recessed surfaces are colored.

5. A method for manufacturing a three-dimensional multilayer structure of a food vessel, comprising:
S1) establishing a three-dimensional coordinate system, and defining a model of an inner container in the three-dimensional coordinate system;
S2) projecting a pattern to a surface of the model of the inner container in the three-dimensional coordinate system;
S3) transforming the pattern into a plurality of recessed surfaces according to colors and textures of the pattern, and setting the plurality of recessed surfaces to formed at different depths;
S4) controlling a computer numerical control (CNC) machine tool to manufacture an injection mold based on the model of the inner container;
S5) forming the inner container by injection molding according to the injection mold;
S6) coloring the plurality of recessed surfaces of the inner container according to the colors and the textures of the pattern;
S7) providing a light transmissive outer container, and assembling the inner container with the outer container to perform a sealing procedure on the inner container and the outer container; and
S8) finishing assembly of the three-dimensional multilayer structure of the food vessel.

6. The method of claim 5, wherein the sealing procedure in step (S7) comprises:
S71) providing an opening ring to couple on and cover upper edges of the outer container and the inner container.

7. The method of claim 5, wherein the sealing procedure in step (S7) comprises:
S72) providing a high-frequency welding apparatus for heating and welding an upper edge of the inner container to form a flange at the upper edge of the inner container, the flange extending outward to cover an upper edge of the outer container.

8. The method of claim 5, wherein the three-dimensional coordinate system is a cylindrical coordinate system.
